(19) United States
(12) Patent Application Publication
(10) Pub. No.: US 2006/0265964 A1
(43) Pub. Date: Nov. 30, 2006

(54) Self aligning barrier panels for automobile door assemblies

(76) Inventor: Jay Winborn, Berkley, MI (US)

Correspondence Address: BUTZEL LONG, 350 SOUTH MAIN STREET, SUITE 300, ANN ARBOR, MI, 48104, US

(21) Appl. No.: 11/264,988

(22) Filed: Nov. 2, 2005

Related U.S. Application Data
(63) Continuation-in-part of application No. 11/134,942, filed on May 23, 2005.
(63) Continuation-in-part of application No. 11/214,483, filed on Aug. 29, 2005.

(51) Int. Cl. B60J 5/04

(52) U.S. Cl. 49/502

(57) ABSTRACT

Barrier panels for motor vehicle door assemblies that include self aligning structures that are received in at least one opening provided in the inboard surface of a door panel. The self aligning structures can include a combination of alignment structures that are provided with engaging structure, alignment structures that are not provided with engaging structures, alignment bosses, two-way locating bosses and/or four-way locating bosses. The self aligning structures can be received in a single common opening or recess provided in a door panel or more that one or separate openings or recesses provided in a door panel.

### RELATED APPLICATIONS

The present application is a Continuation-In-Part of U.S. patent application Ser. No. 11/134,942, filed May 23, 2005 entitled “Automobile Door Assemblies” and of U.S. patent application Ser. No. 11/214,483, filed Aug. 29, 2005, entitled “Multi-Sheet Barrier Panel for Automobile Door Assemblies,” to each of which priority is claimed under 35 U.S.C. §120 and of each of which the entire specification is hereby expressly incorporated by reference.

### TECHNICAL FIELD

The present invention relates to vehicle door assemblies that include barrier panels which prevent the ingress of water into a vehicle passenger compartment. More particularly, the present invention relates to barrier panels for vehicle door assemblies that include self aligning structures that are configured to align the barrier panels to door panels during assembly of vehicle door assemblies.

### BACKGROUND ART

Automobile door assemblies generally include a door panel to which an inner trim panel is joined. The door panel includes a cavity within which the door window may be lowered. This cavity may also contain window regulating equipment, door locks, sound speakers, air bag systems, and the like. The inner trim panel is typically a rigid or semi-rigid panel formed of a cloth-like or plastic trim material which serves as the interior passenger compartment panel.

Door assemblies are susceptible to the ingress of water which can enter into door cavities through the openings through which the door windows slide. Holes are generally formed in the bottom of door assemblies to allow any water that enters the door cavities to drain out. However, as water enters door cavities and runs down toward the drain holes, it can seep into and through the inner trim panels unless a barrier of some type is provided in the assembly.

In order to protect inner trim panels from becoming wet and possibly stained or otherwise damaged, it is common to attach panel liners over door panels beneath inner trim panels. Such panel liners are often made of a treated paper material or can comprise a thin plastic film. The panel liners function to deflect any water entering door cavities so that the water runs down the liners to the bottoms of the door cavities without contacting the inner trim panels.

Liners used in door assemblies are typically sealed to the door panels of door assemblies by an adhesive which is provided as a bead that extends along the periphery of the liners. In order to protect the adhesive bead, a release sheet is secured to the liners over the adhesive bead. The release sheet has to be removed when a liner is applied to a door panel of a door assembly.

Inner trim panels of door assemblies are typically attached to door panels by a plurality of push-in fasteners that are commonly referred to as “Christmas trees.” The push-in fasteners extend outward from the outboard side of the inner trim panels and are spaced apart adjacent the peripheral edge of the inner trim panels. The inboard surface of the door panels include through-holes which are aligned to receive the push-in fasteners provided on the inner trim panels. The inner trim panels are attached to the door panels by aligning and pushing the push-in fasteners on the inner trim panels into the through-holes in the door panels.

When assembling door assemblies liners are often attached to the inner trim panels by the plurality of push-in fasteners with the outboard side of the barrier panels having the adhesive bead facing the door panels. The push-in fasteners hold and align the liners in position until the push-in fasteners are received in the through-holes in the door panels.

The present invention provides for barrier panels that are configured and designed to self align with door panels without having to be attached to inner trim panels.

### DISCLOSURE OF THE INVENTION

According to various features, characteristics and embodiments of the present invention which will become apparent as the description thereof proceeds, the present invention provides a barrier liner for a vehicle door assembly which includes:

a sheet of substantially water-impermeable material that is substantially complimentarily shaped to the door panel having an inboard surface and an outboard surface; and

a plurality of self aligning structures that extend outward from the outboard surface of the sheet of substantially water-impermeable material and which are configured to be received in at least one opening formed in an inboard surface of a door panel in when the barrier panel is properly aligned with the door panel.

The present invention further provides a method of assembling a door assembly which involves:

providing a door panel having at least one opening formed in an inboard surface thereof;

providing an inner trim panel;

providing a barrier liner having a plurality of self alignment structures that extend outward from an outboard surface of the barrier liner;

aligning the plurality of self alignment structures with the at least one opening formed in the inboard surface of the door panel;

pushing the barrier liner against the door panel so that the self aligning structures are received in the at least one opening formed in the inboard surface of the door panel;

attaching the barrier panel to the door panel; and

attaching the inner trim panel to the door panel over the barrier liner.

The present invention also provides for door assemblies that include the barrier panels that include the self aligning structures.

### BRIEF DESCRIPTION OF DRAWINGS

The present invention will be described with reference to the attached drawings which are given as non-limiting examples only, in which:

FIG. 1 is an exploded perspective view of a conventional motor vehicle door assembly that includes a barrier panel.

FIG. 2 is a planar view of a door assembly according to one embodiment of the present invention.

FIG. 3 is a cross sectional view of the door assembly of FIG. 2 taken along section lines 3.

FIG. 4 is a cross sectional view of the door assembly of FIG. 2 taken along section lines 4.

FIG. 5 is a planar view of a door assembly according to another embodiment of the present invention.

FIG. 6 is a cross sectional view of the door assembly of FIG. 5 taken along section lines 6.

FIG. 7 is a cross sectional view of the door assembly of FIG. 5 taken along section lines 7.

FIG. 8 is a perspective view of a barrier panel according to another embodiment of the present invention.

FIG. 9 is a planar view of the barrier panel of FIG. 8.

FIG. 10 is a cross sectional view of the barrier panel of FIG. 8 taken along section lines 10.

FIG. 11 is a cross sectional view of the barrier panel of FIG. 8 taken along section lines 11.

FIG. 12 is a cross sectional view of the barrier panel of FIG. 8 taken along section lines 12.

FIG. 13 is planar view of a door assembly according to another embodiment of the present invention.

FIG. 14 is a cross sectional view of the door assembly of FIG. 13 taken along section lines 14.

FIG. 15 is a cross sectional view of the door assembly of FIG. 13 taken along section lines 15.

FIG. 16 is a cross sectional view of the door assembly of FIG. 13 taken along section lines 16.

FIG. 17 is planar view of a door assembly according to another embodiment of the present invention.

FIG. 18 is a cross sectional view of the door assembly of FIG. 17 taken along section lines 18.

FIG. 19 is a cross sectional view of the door assembly of FIG. 17 taken along section lines 19.

### BEST MODE FOR CARRYING OUT THE INVENTION

The present invention is directed to water seal or barrier panels (herein generally referred to as “barrier panels”) for vehicle door assemblies that include self aligning structures that are configured and arranged to cooperate with features of a door panel to align the barrier panels with door panels during the assembly of a vehicle door assembly. The barrier panels of the present invention are configured to be received between an inner trim panel and a door panel of a door assembly and can include a bead of a conventional sealant/adhesive material to provide a peripheral seal against the door panels. Alternatively, a peripheral sealing element can be molded an integrated onto the outboard surface of the barrier panels. In addition to the self aligning features, the barrier panels of the present invention are complementary shaped to the inner or inboard surface of a door panel at least around the periphery thereof and can include engaging structures that are configured and aligned to engage the edge of one or more openings provided in the inboard surface of the door panels.

The barrier panels can be made from a variety of moldable materials such as polyethylene, polystyrene, abs plastics, polypropylene, foamable plastics, etc. and can comprise a single sheet or two or more sheets that are bonded together in a sealed and spaced apart manner at discrete portions. When the barrier panel comprises two or more sheets that are bonded together, areas in the space between adjacent sheets can be hollow or can contain or be filled with acoustic and/or thermal insulation materials such as noise absorbing materials or materials with low thermal conductivity.

The self aligning structures can include engaging structures that can be molded into or onto the self aligning structures or adjacent or between adjacent self aligning structures on the barrier panels when they are fabricated. The engaging structure can comprise hollow, solid, or semi-hollow structures, or linked structures or assemblies. Alternatively, the engaging structures can be made separately from the barrier panels and attached or fixed thereto by adhesives, thermal or ultrasonic welding, mechanical fasteners, cooperating engaging structures, etc.

In general the self aligning structures protrude from the outboard surface of a barrier panel and are arranged and aligned so that the self aligning structures are collectively received in a corresponding configuration of openings or recesses or a single opening or recess formed in the inboard surface of a door panel.

When engaging structures are used in combination with the self aligning structures, the engaging structures help apply pressure toward the door panels which has the effect of pressing on the bead of sealant/adhesive materials thereby ensuring the production of a good seal thereby.

In door assemblies that include the barrier panels having self aligning structures according to the present invention, the inner trim panels can be secured to the door panels by mechanical fasteners such as screws, clips, push-in fasteners, etc. generally in a conventional manner. However, when engaging structures are provided it is not necessary for the mechanical fasteners to extend through the barrier panels. Accordingly, the inner trim panels extend beyond the periphery of the barrier panels and the through-holes in the door panels which receive the mechanical fasteners of the inner trim panels are spaced outward from the periphery of the barrier panels. Alternatively, when engaging structures are not included with the self aligning structures the mechanical fasteners that are used to secure the inner trim panels to the door assemblies can extend through the barrier panels.

Features and characteristics of the present invention will be hereafter described with reference to the attached drawings which are provided as non-limiting examples only. Throughout the drawings, similar reference numerals are used to identify common elements when possible in order to simplify the description.

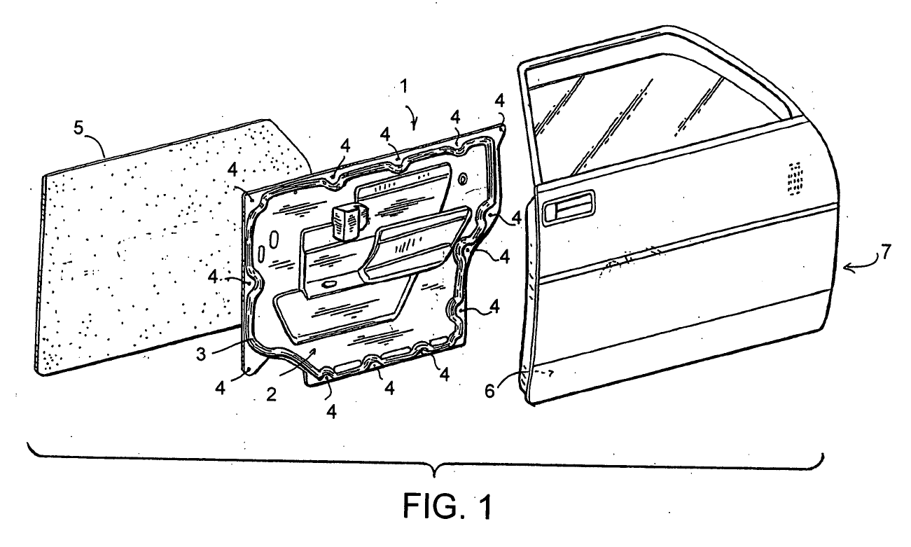

FIG. 1 is an exploded perspective view of a conventional motor vehicle door including a barrier panel. The barrier panel 1 includes a generally planer sheet 2 that has been molded in the center so as to conform to, receive or accommodate various components of a vehicle door such as a door latching handle, window control mechanism, power seat control panel, etc. (none shown). A bead of a conventional sealant/adhesive is disposed near the periphery of the barrier panel.

The barrier panel 1 is positioned between an inner trim panel 5 and door panel 6 of the vehicle door 7. The inner trim panel 5 is attached to the door panel 6 by a plurality of mechanical fasteners (not shown) which can pass through the through-holes 4 provided in the barrier panel 1.

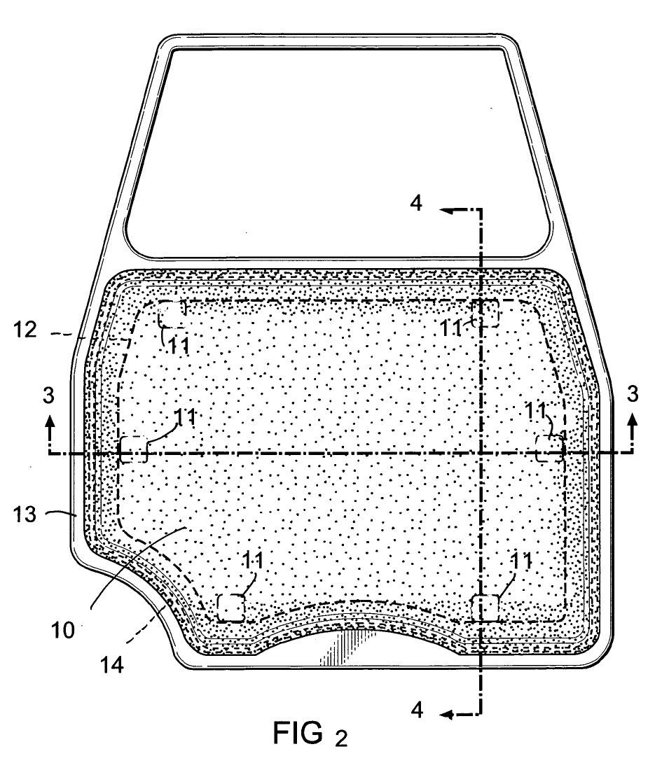

FIG. 2 is a planar view of a door assembly according to one embodiment of the present invention.

The door assembly of FIG. 2 includes a barrier panel 10 that is provided with a plurality of self aligning structures 11 that extend outward from the outboard surface of the barrier panel 10 and are aligned so as to be collectively received in an opening 12 formed in the inboard surface of the door panel 13 in such a manner so as to align the barrier panel 10 with the door panel 13 in a desired fashion, e.g. so the peripheral edge of the barrier panel 10 having a bead of sealant/adhesive 14 on the outboard surface seals against the door panel 13 and can be covered by an interior trim panel (not shown).

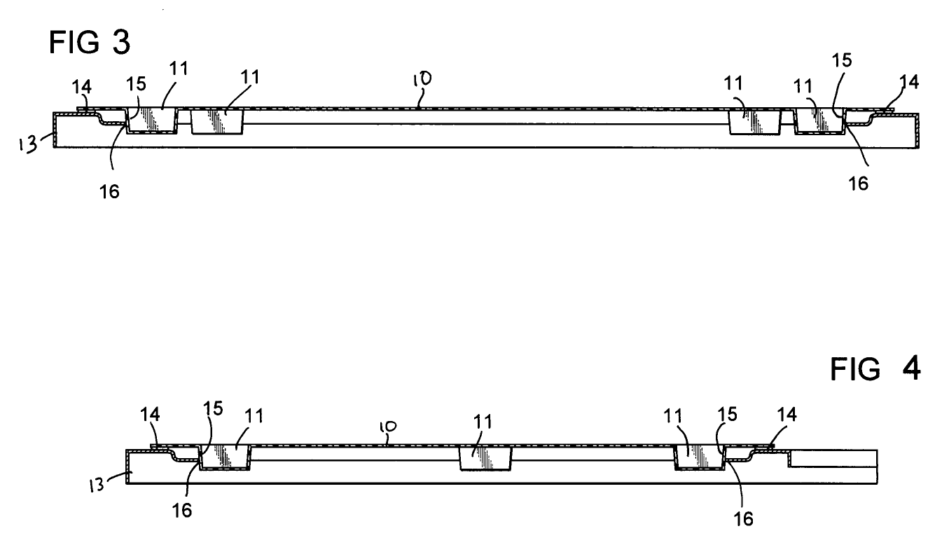

FIG. 3 is a cross sectional view of the door assembly of FIG. 2 taken along section lines 3. FIG. 4 is a cross sectional view of the door assembly of FIG. 2 taken along section lines 4. As shown in FIGS. 3 and 4, the outer walls 15 of the self aligning structures 11 are configured to abut the edge 16 of opening 12 formed in door panel 13 so as to align the barrier panel 10 within the edge 16 of opening 12.

The self aligning structures 11 shown in FIGS. 2-4 are depicted as being hollow and formed integrally with the barrier panel. In other embodiments, including the embodiments illustrated herein, the self aligning structures 11 can be solid or semi-solid and formed integrally with, or separately from and attached to, the barrier panels 10.

The barrier panels 10 of the present invention can be made from a variety of moldable, water impermeable materials such as polyethylene, polystyrene, abs plastics, polypropylene, foamable plastics, etc. and can comprise a single sheet or two or more sheets that are bonded together in a sealed and spaced apart manner at discrete portions. Also, as noted above, the barrier panels 10 can comprise a single sheet or two or more sheets that are bonded together in a sealed and spaced apart manner at discrete portions. When the barrier panels 10 comprises two or more sheets that are bonded together, areas in the space between adjacent sheets can be hollow or can contain or be filled with acoustic and/or thermal insulation materials such as noise absorbing materials or materials with low thermal conductivity.

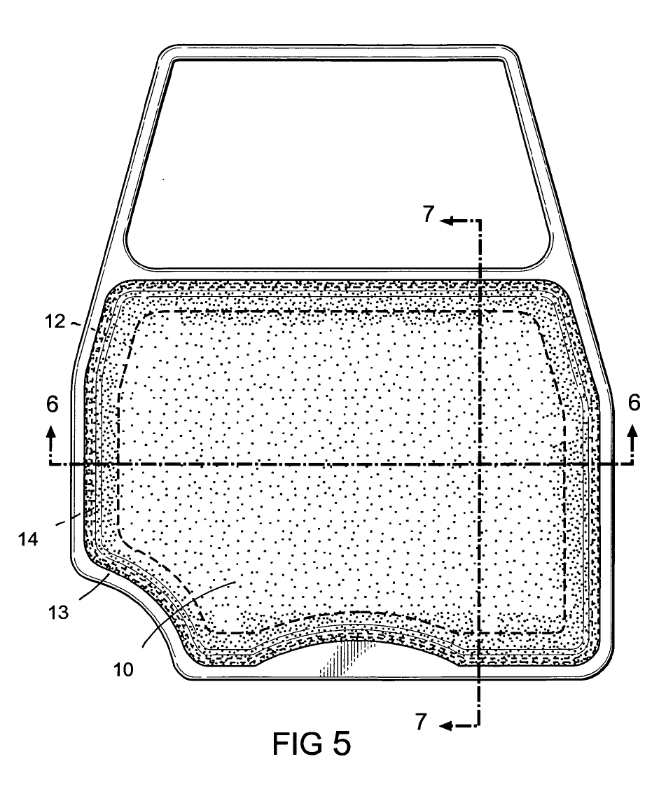

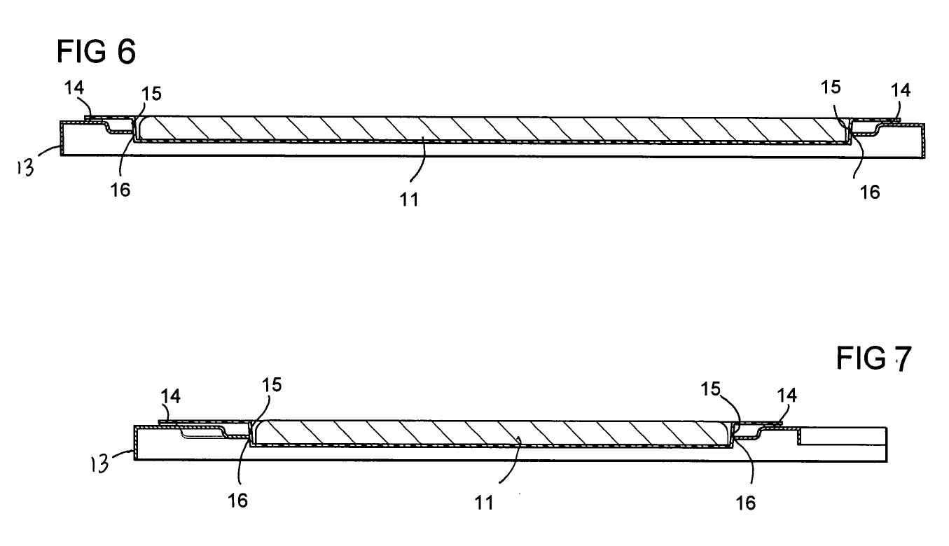

FIG. 5 is a planar view of a door assembly according to another embodiment of the present invention. FIG. 6 is a cross sectional view of the door assembly of FIG. 5 taken along section lines 6. FIG. 7 is a cross sectional view of the door assembly of FIG. 5 taken along section lines 7. The barrier panel 10 depicted in FIGS. 5-7 includes a central area that protrudes outwardly in the outboard direction and is complementarily shaped to an opening 12 formed in the inboard surface of the door panel 13 the protruding central area defines a single self aligning structure 11 that can only be received in the opening 12 in one orientation as shown in which the peripheral wall 15 of the protruding self aligning structure 11 abuts and is received within the edge 16 of opening 12 while the outer peripheral portion of the barrier panel 10 having sealant/adhesive bead 14 thereon extends outward over the portion of the inboard surface of the door panel 13 that surrounds opening 12.

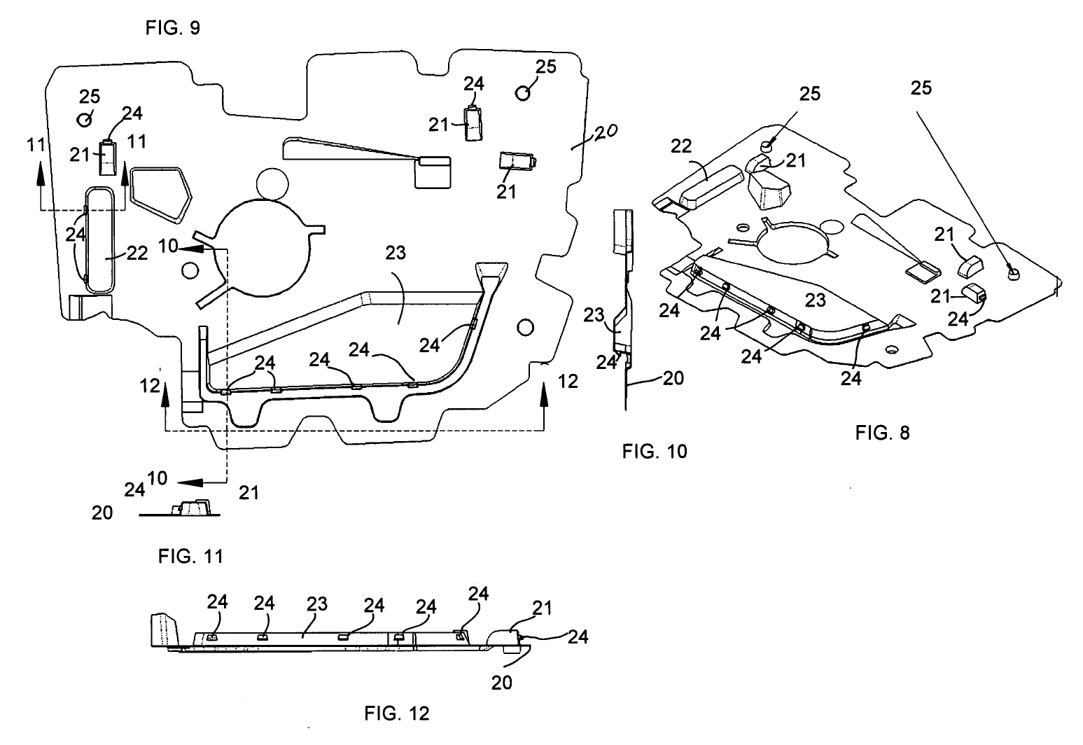

FIG. 8 is a perspective view of a barrier panel according to another embodiment of the present invention. FIG. 9 is a planar view of the barrier panel of FIG. 8. The barrier panel 20 depicted in FIGS. 8 and 9 includes several different shaped self aligning structures 21, 22 and 23. Self aligning structures 21, 22 and 23 are provided with engaging structures 24 that are positioned and aligned to engage the edge of a common opening formed in the inboard surface of a door panel (not shown). Self aligning structures 21 include a single engaging structure 24. Self aligning structure 22 has an elongated shape and is provided with two engaging structures 24. Self aligning structure 23 is contoured to conform to a lower corner portion of an opening provided in the inboard surface of a door panel and is provided with a plurality of engaging structures 24 which are spaced apart along the outer periphery of the self aligning structure 23 so as to engage the lower edge of the opening and a portion of the side edge of the opening.

In addition to self aligning structures 21, 22 and 23 which are provided with engaging structures 24 that engage the edge of a common opening provided in the inboard surface of a door panel, the barrier panel 20 depicted in FIGS. 8 and 9 include alignment bosses 25, which as can be seem in FIG. 9 are positioned to be received in complementarily shaped boss openings provided in the inboard surface of a door panel outside of the opening which receives the self aligning structures 21, 22 and 23 having the engaging structures 24.

FIG. 10 is a cross sectional view of the barrier panel of FIG. 8 taken along section lines 10. FIG. 11 is a cross sectional view of the barrier panel of FIG. 8 taken along section lines 11. FIG. 12 is a cross sectional view of the barrier panel of FIG. 8 taken along section lines 12. As can be seen in FIGS. 10-12 the self aligning structures 21, 22 and 23 and alignment bosses 25 protrude outward from the outboard surface of the barrier panel 20 so as to be received in the openings provided in the inboard surface of a door panel. The self aligning structures 21, 22 and 23 are aligned and configured to be received in a common opening in the center of the inboard surface of a door panel so that the engaging structures 24 on the self aligning structures 21, 22 and 23 engage the edge of the opening. The alignment bosses 25 are aligned and configured to be received in separate openings provided in the inboard surface of a door panel.

It is to be understood that the embodiment of the invention depicted in FIGS. 9-12 is only exemplary and that the number, and alignment and configuration of the self aligning structures and alignment bosses can be varied as desired for different barrier panels, door panels and/or door assemblies. Also, the number of engaging structures can be varied as desired and engaging structures that do not include engaging structures can be used together with and between those that do include engaging structures if desired.

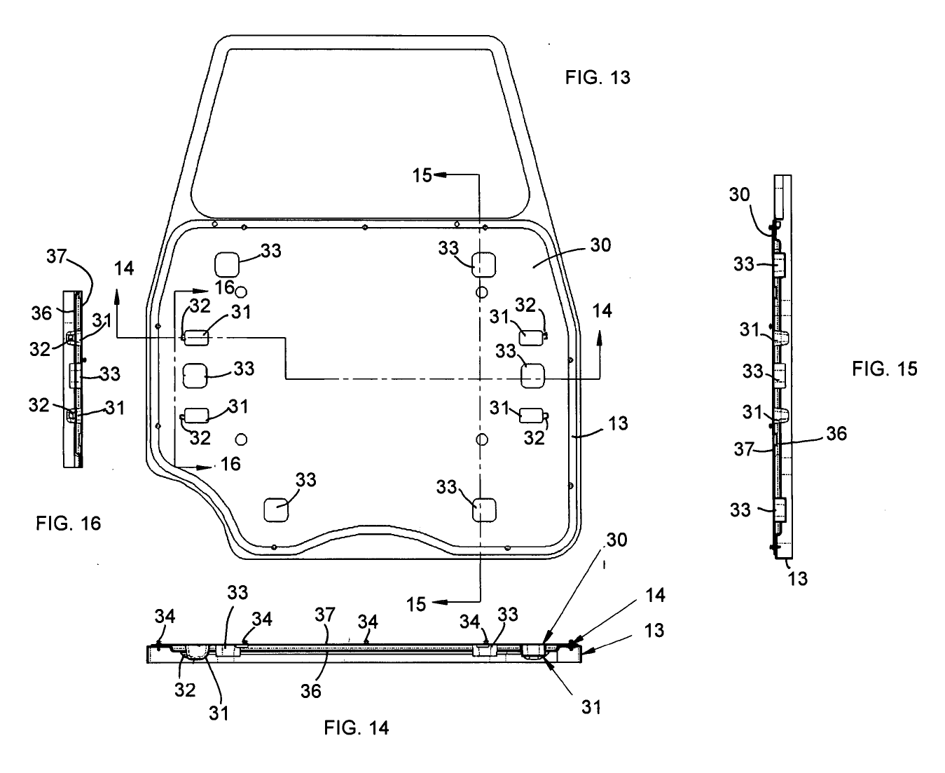

FIG. 13 is planar view of a door assembly according to another embodiment of the present invention. The barrier panel 30 depicted in FIG. 13 includes a combination of self aligning structures 31 that have engaging structures 32, self aligning structures 33 that do not have engaging structures. In the embodiment of the invention depicted in FIG. 13, self aligning structures 31 and 33 are configured and aligned to be received in openings provided in door panel 13 as shown. The self aligning structures 31 having engaging structures 32 are configured so that the engaging structures 32 engage edge portions of the openings into which they are received in the inboard surface of door panel 13.

FIG. 14 is a cross sectional view of the door assembly of FIG. 13 taken along section lines 14. FIG. 15 is a cross sectional view of the door assembly of FIG. 13 taken along section lines 15. FIG. 16 is a cross sectional view of the door assembly of FIG. 13 taken along section lines 16. The door panel 13 includes separate openings for receiving each of alignment structures 31 and 33. As shown in FIGS. 14 and 16, the self aligning structures 31 having the engaging structures 32 protrude further out from the outboard surface of the barrier panel 30 than the self aligning structures 33 that do not include engaging structures. This is because the engaging structures 32, as shown in FIGS. 14 and 16 have to extend through the openings provided in the door panel 13 and further extend so as to engage the outboard surface of the door panel 13 whereas the self alignment structures 31 that are not provided with engaging structures only have to extend into the openings provided in the door panel 13.

In FIGS. 13-16 conventional mechanical fasteners 34 are depicted as securing the outer edges of the barrier panel 30 to the door panel 13.

The door panel 30 depicted in FIGS. 13-16 has a recessed central area as seen in FIGS. 14-16 and the barrier panel comprises two sheets with the outboard-most sheet 36 lying against the inboard surface of the door panel and the inboard-most sheet 37 extending across the recessed central portion of the door panel 13. The space between the two sheets of the barrier panel 30 can contain of be filled with an acoustic and/or thermal insulation material such as noise absorbing materials or materials with low thermal conductivity in order to provide a sound and/or thermal barrier for the door assembly. It is also possible to provide some reinforcing structures between the two sheets 36 and 37 that form the barrier panel 30, including a pattern of depressions in one or both sheets that help space the sheets apart and provide strength to the barrier panel 30.

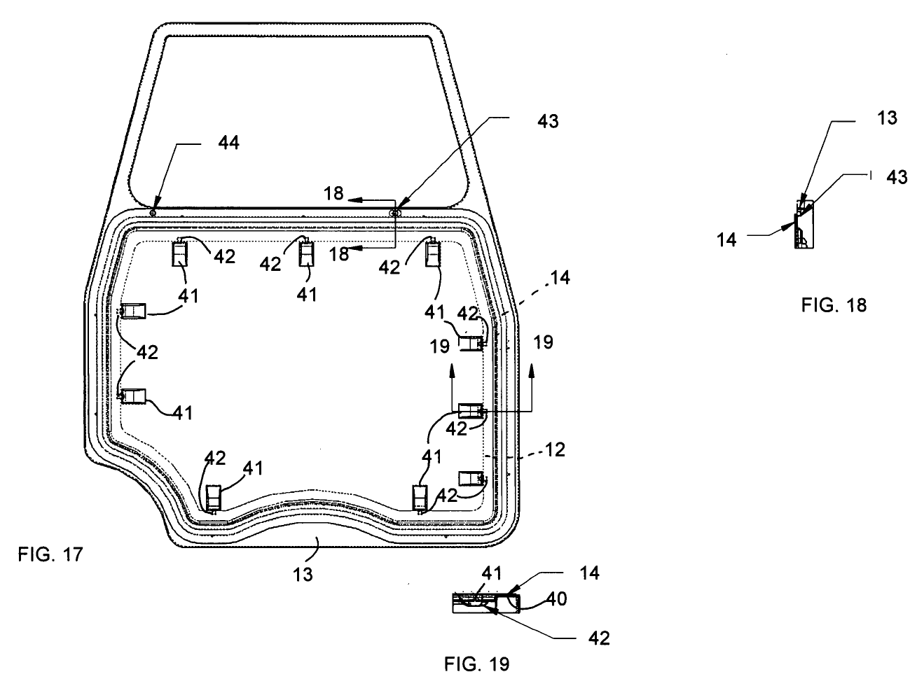

FIG. 17 is planar view of a door assembly according to another embodiment of the present invention. The barrier panel 40 depicted in FIG. 17 includes a plurality of self aligning structures 41 that are aligned and configured to be collectively received in a common opening 12 provided in the inboard surface of door panel 13. The self aligning structures 41 further include engaging structures 42 that are configured to engage the edge of the opening 12 provided in the inboard surface of the door panel 13.

In addition to the self aligning structures 41, the barrier panel 40 of FIG. 17 includes locator bosses, including for illustrative purposes a two-way locator boss 43 and a four-way locator boss 44. The two-way locator boss 43 has a substantially elongated rectangular cross sectional shape as viewed in FIG. 17 and is received in a corresponding substantially elongated rectangular cross sectional opening or recess provided in the inboard surface of door panel 13.

The four-way locator boss 44 has a non-linear cross sectional shape as viewed in FIG. 17 than can be in the form or a plus sign (“+”), or an X or Y or diamond or circular or oval or triangular or any shape that, in order to be received in a correspondingly shaped opening or recess in the door panel 13, requires proper alignment along more than one linear direction, as opposed to the two-way locator boss 43 that only requires alignment along the central axis of the substantially elongated rectangular cross sectional opening provided in the inboard surface of door panel 13 and could slide along the opening if the opening were longer than the two-way locator boss 43.

FIG. 18 is a cross sectional view of the door assembly of FIG. 17 taken along section lines 18. FIG. 18 depicts the two-way locator boss 43 extending into a corresponding opening 12 provided in the inboard surface of the door panel 13 and a portion of self aligning structure 41 extending into opening 12 provided in the inboard surface of the door panel 13 so that engaging structure 42 provided on self aligning structure 41 engages the edge of opening 12.

FIG. 19 is a cross sectional view of the door assembly of FIG. 17 taken along section lines 19. FIG. 19 depicts self aligning structure 41 extending into opening 12 provided in the inboard surface of the door panel 13 so that engaging structure 42 provided on self aligning structure 41 engages the edge of opening 12. FIGS. 18 and 19 also show a bead 14 of a sealant/adhesive material that is provided between the barrier panel 40 and door panel 13.

To assemble a door assembly using the barrier panels having the self aligning structures thereon, one removes any release sheet that covers the sealant/adhesive bead and pushes the barrier panel against the inboard surface of a door panel so that each of the self aligning structures is received in a correspondingly shaped opening or recess formed in the inboard surface of the door panel. When the barrier panel is provided with engaging structures in addition to the self aligning structures, the engaging structures engage the edge(s) of openings provided in the inboard surface of the door panel. An inner trim panel can be attached to the door panel over the barrier panel using conventional fasteners, such as push-in fasteners which are receive in through-holes provided in the inboard surface of the door panel.

The barrier panels and door assemblies of the present invention can be used in conjunction with any type of vehicle door assembly, including front and rear door assemblies, sliding door assemblies, and rear door assemblies.

While the present invention has been described so as to provide an understanding of how the barrier panels self align during the assembly of a door assembly, it is noted that in addition to the openings that are provided in the inboard surface of the door panels for receiving the self aligning structures and/or alignment bosses, addition openings may be provided for various mechanisms of the door or for access inside the door. In addition, rather than provide openings in the inboard surface of the door panels to receive self aligning structures or alignment bosses or locator bosses, complementary shaped recesses could be formed in the inboard surface of the door panels to receive the self aligning structures or alignment bosses or locator bosses.

Although the present invention has been described with reference to particular means, materials and embodiments, from the foregoing description, one skilled in the art can easily ascertain the essential characteristics of the present invention and various changes and modifications can be made to adapt the various uses and characteristics without departing from the spirit and scope of the present invention as described above and in the attached claims.

What is claimed is:

1. A barrier liner for a vehicle door assembly which comprises:
a sheet of substantially water-impermeable material that is substantially complimentarily shaped to the door panel having an inboard surface and an outboard surface; and
a plurality of self aligning structures that extend outward from the outboard surface of the sheet of substantially water-impermeable material and which are configured to be received in at least one opening formed in an inboard surface of a door panel in when the barrier panel is properly aligned with the door panel.

2. A barrier liner for a vehicle door assembly according to claim 1, wherein the plurality of self aligning structures are aligned and configured to be received in a common opening provided in the inboard surface of the door panel.

3. A barrier liner for a vehicle door assembly according to claim 2, wherein each of the plurality of self aligning structures extends through the common opening and abuts an edge of the common opening.

4. A barrier liner for a vehicle door assembly according to claim 1, wherein the plurality of self aligning structures have substantially the same cross sectional shape.

5. A barrier liner for a vehicle door assembly according to claim 1, wherein the plurality of self aligning structures include self aligning structures that have different cross sectional shapes.

6. A barrier liner for a vehicle door assembly 1, wherein the plurality of self aligning structures comprise a single self aligning structure and the at least one opening extends across a major portion of door panel.

7. A barrier liner for a vehicle door assembly according to claim 1, wherein the plurality of self aligning structures comprises at least two of: i) self aligning structures that include engaging structure; ii) self aligning structures that do not include engaging structures; iii) alignment bosses; and iv) locator bosses.

8. A barrier liner for a vehicle door assembly according to claim 7, wherein the locator bosses comprise at least one of two-way locator bosses and four-way locator bosses.

9. A barrier liner for a vehicle door assembly according to claim 1, wherein at least one of the plurality of self aligning structures includes a plurality of engaging structures.

10. A barrier liner for a vehicle door assembly according to claim 1, wherein the barrier panel comprises two sheets of substantially water-impermeable material that have spaced apart portions.

11. A barrier liner for a vehicle door assembly according to claim 10, further comprising at least one of an acoustic and a thermal insulation material provided between the two sheets of substantially water-impermeable material in the spaced apart portions.

12. A method of assembling a door assembly which comprises:
providing a door panel having at least one opening formed in an inboard surface thereof;
providing an inner trim panel;
providing a barrier liner having a plurality of self alignment structures that extend outward from an outboard surface of the barrier liner;
aligning the plurality of self alignment structures with the at least one opening formed in the inboard surface of the door panel;
pushing the barrier liner against the door panel so that the self aligning structures are received in the at least one opening formed in the inboard surface of the door panel;
attaching the barrier panel to the door panel; and
attaching the inner trim panel to the door panel over the barrier liner.

13. A method of assembling a door assembly according to claim 12, wherein the plurality of self aligning structures are aligned and configured to be received in a common opening provided in the inboard surface of the door panel.

14. A method of assembling a door assembly according to claim 13, wherein each of the plurality of self aligning structures extends through the common opening and abuts an edge of the common opening.

15. A method of assembling a door assembly according to claim 12, wherein the plurality of self aligning structures have substantially the same cross sectional shape.

16. A method of assembling a door assembly according to claim 12, wherein the plurality of self aligning structures include self aligning structures that have different cross sectional shapes.

17. A method of assembling a door assembly according to claim 12, wherein the plurality of self aligning structures comprise a single self aligning structure and the at least one opening extends across a major portion of door panel.

18. A method of assembling a door assembly according to claim 12, wherein the plurality of self aligning structures comprises at least two of: i) self aligning structures that include engaging structure; ii) self aligning structures that do not include engaging structures; iii) alignment bosses; and iv) locator bosses.

19. A method of assembling a door assembly according to claim 18, wherein the locator bosses comprise at least one of two-way locator bosses and four-way locator bosses.

20. A method of assembling a door assembly according to claim 12, wherein at least one of the plurality of self aligning structures includes a plurality of engaging structures.

21. A method of assembling a door assembly according to claim 12, wherein the barrier panel comprises two sheets of substantially water-impermeable material that have spaced apart portions.

22. A method of assembling a door assembly according to claim 21, further comprising at least one of an acoustic and a thermal insulation material provided between the two sheets of substantially water-impermeable material in the spaced apart portions.

23. A door assembly that comprises the barrier panel of claim 1
